(19) United States
(12) Patent Application Publication
(10) Pub. No.: US 2014/0258043 A1
(43) Pub. Date: Sep. 11, 2014

(54) COMPARABLE PRODUCT MATCHING: SYSTEM AND METHOD

(71) Applicants: Troy E. McCabe, Eagan, MN (US); Trent M. Kannenberg, Prior Lake, MN (US)

(72) Inventors: Troy E. McCabe, Eagan, MN (US); Trent M. Kannenberg, Prior Lake, MN (US)

(73) Assignee: BBY SOLUTIONS, INC., Richfield, MN (US)

(21) Appl. No.: 13/792,274

(22) Filed: Mar. 11, 2013

(51) Int. Cl. G06Q 30/06

(52) U.S. Cl. CPC G06Q 30/0629
USPC 705/26.64

(57) ABSTRACT

A method and system for matching a basis product with products in the inventory of a provider (e.g., a retailer) that have related functionality. Characteristics of the basis product may be known from its product identifier, or may be specified. Goodness scores for candidate products may be based on similarity of characteristics with those of the basis product. Availability and consumer preferences may be taken into account in assigning goodness scores. Candidates may be drawn from those in inventory having the same type as the basis product, or a type having one or more similar functional aspects. Values of characteristics may require reformatting and/or normalization to facilitate comparison. A list of candidates, ranked by goodness scores, may be prepared.

### FIELD OF THE INVENTION

The present invention relates generally to a method and apparatus for finding comparable products using a processing system. More specifically it is directed to searching an inventory catalog of product characteristics to find products that are comparable to a given product.

### SUMMARY OF THE INVENTION

A method and system for matching a basis product with products in the inventory of a provider (e.g., a retailer) that have related functionality. We will use the term “basis product” for a product that is presented so that viable “comparables” can be identified. A person requesting comparables may present an existing product for matching, perhaps one that is no longer manufactured, or one not offered by a particular provider.

We assume that the type of the individual basis product is known or can be determined. Characteristics of the basis product may be known from its product identifier, or may be specified. The search for a comparable product from an inventory may take into account a variety of characteristics, such as general functionality, detailed features, price range, manufacturer, ratings, and reviews.

For example, characteristics of a camera may include, for example: analog versus digital; number of megapixels; single-lens reflex (SLR) versus non-SLR; properties of build-in or included lenses; video capabilities; size; weight; manufacturer; warranty length and terms; and ratings/reviews. Some of product characteristics are binary—either a camera is SLR or not—or have some finite number of discrete values (e.g., color, or manufacturer ID). Other factors, such as the number of megapixels in a digital camera, lend themselves to being quantified and compared numerically. Some factors for matching are strings of characters—for example, a customer might want a coffee cup that displays the slogan, “Keep Austin Weird”®. This example also illustrates that a factor might be decorative rather than functional. Other features, which might be considered as taking on a finite number of discrete values, might nevertheless be input to a matching algorithm in string form. For example, manufacturer might be input as a string; similarly, the term “Dishwasher Safe”.

Finding comparables requires that the processing logic consider candidate types in a catalog. In a retail context, the candidate types may be stock-keeping units (SKUs). The candidate SKUs may represent real tangible objects, possibly on the retailer's sales floor, in inventory, in a distribution center, or available from a third party.

Goodness scores for candidate products may be based on similarity of characteristics with those of the basis product. A scheme for weighting individual characteristics in arriving at a goodness score may be itself stored in tangible digital storage; there might be a user interface whereby a user (possibly the requester or the provider) can adjust various weightings. Availability and requester preferences may be taken into account in assigning goodness scores. Candidates may be drawn from those in inventory having the same type as the basis product, or a type having one or more similar functional aspects. Values of characteristics may require reformatting to make them comparable; and/or normalization of values if a candidate characteristic involves a different but functionally similar technology. A list of candidates, ranked by goodness scores, may be prepared, and transmitted for presentation to the requester.

Candidates might be sought from more than one product type. For example, suppose that the requester presents a small portable video cassette player as the basis product. A search for products might consider tablet computers, laptops, and DVD player types, and produce a list of ranked candidates from all three types.

### BRIEF DESCRIPTION OF THE DRAWINGS

FIG. 1 is a conceptual diagram illustrating product matching.

FIG. 2a is a flowchart illustrative of a process for finding the best matching product in an inventory to a basis product that is not contained in the inventory.

FIG. 2b is a flowchart illustrative of a process for finding the best matching product in an inventory to a basis product that is contained in the inventory.

FIG. 3 is a flowchart illustrative of a process for normalizing a characteristic of a first product type to make it comparable to a characteristic of a second product type.

FIG. 4 is a flowchart illustrative of a process for finding the best matching alternative to a basis product having a given type, from a set of products having either the same type as the basis product or a type with some similar functionality but different technology.

FIG. 5 is a conceptual diagram illustrative of a system that might implement the inventive concepts.

### DETAILED DESCRIPTION OF EXEMPLARY EMBODIMENTS

The figures and description below provide illustrative examples of the inventive concepts. The scope of the inventive concepts described herein is not limited to these examples.

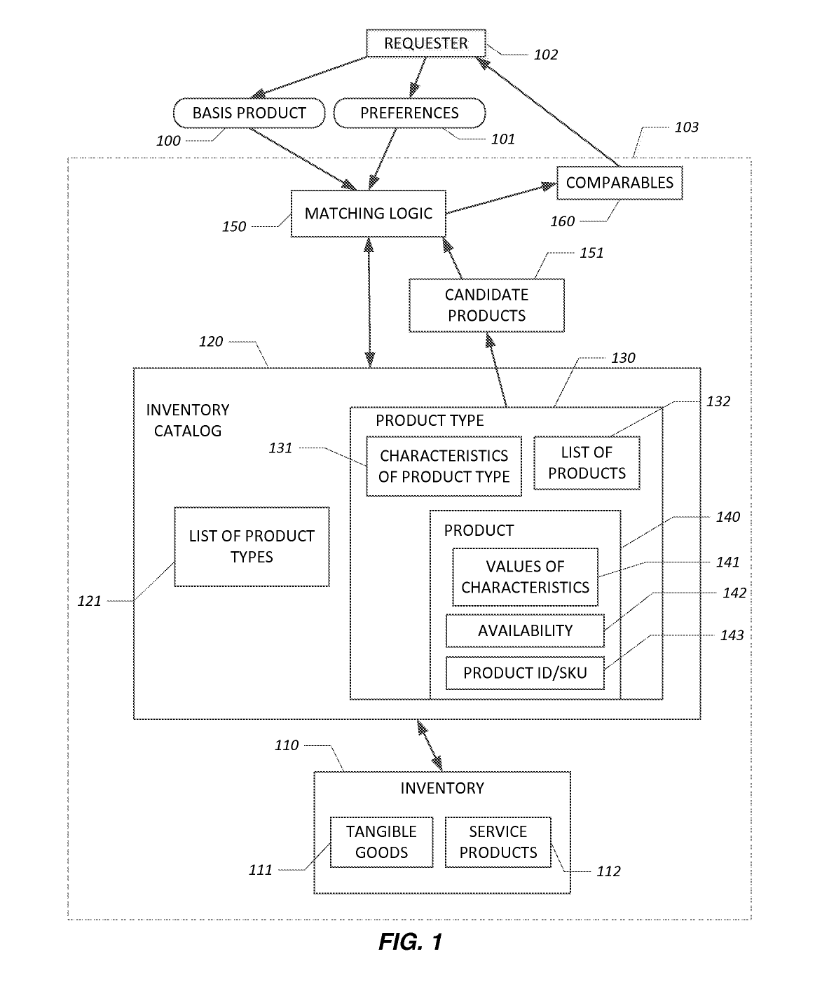

FIG. 1 is a conceptual diagram illustrating matching of a basis product 100 to comparable items in catalog 120 of inventory 110 of a provider 103 of goods or services. A provider 103 might be, for example, a retailer, a wholesaler, a manufacturer, a warehouse, or a storeroom. The person or entity requesting the information is a requester 102. In a retail environment, the requester 102 might be, for example, a customer or a salesperson.

The inventory catalog 120 contains information about products 140, in the illustrated example, stock-keeping units (SKUs) in an inventory 110. The inventory 110 itself includes tangible goods 111 and/or service products 112. The inventory 110 might be in a single location, or dispersed into several locations, such as stores, distribution centers, and vehicles. The inventory 110 might include products 140 that can be obtained by the provider 103 from third-party suppliers.

The catalog 120 is contained digitally in tangible storage 540, such as a combination of hard drives, optical disks, or memory. The catalog 120 may organize the available products 140 into some hierarchy, such as classes, subclasses, and so forth. Generically, a product 140 has a type 130, which might correspond to any level in such a hierarchy, possibly the highest level of organization. The catalog 120 defines a set of product types 130, which may be represented as some kind of list, a term we use broadly.

Generally, each product type 130 will have its own set of product type characteristics 131 that distinguish individual products 140 in the product type 130 from those of other product types 130. A product type characteristic 131 might be binary, such as the presence or absence of a feature, or have a finite number of discrete values, such as choices from available colors. A product type characteristic 131 might be a size or a length or a weight or a count, allowing values of the product type characteristic 131 to be compared using subtraction. A product type characteristic 131 might be a string, such as the name of a manufacturer. Generally, each product type 130 will have a unique combination of product type characteristics 131, although an individual product type characteristic 131 can pertain to one or multiple product types 130.

A products list 132 associates a product type 130 with a set of products 140 within the inventory 110. We will assume that each product 140 has a unique product identifier (ID) 143, which in a retail context, might be a SKU. The products 140 of a given product type 130 may have values 141 of some or all of the product type characteristics 131. The provider 103 might want to take into account availability 142 of a product 140 in deciding which comparable products 160 to recommend. The availability 142 is an indication of how difficult it would be for the provider 103 to furnish the product 140 to a customer or other requester. Obtaining an availability 142 might require a query over a communication system 520, such as a wide-area network.

In the illustrative product matching system of FIG. 1, a customer might present a DVD player, the basis product 100, to a salesperson in a store, inquiring about a possible replacement or upgrade. The customer might also specify preferences 101 about desirable characteristics of the new comparable product 160. The salesperson might be able to determine that the product 140 corresponds to a product ID 143 not currently in inventory 110.

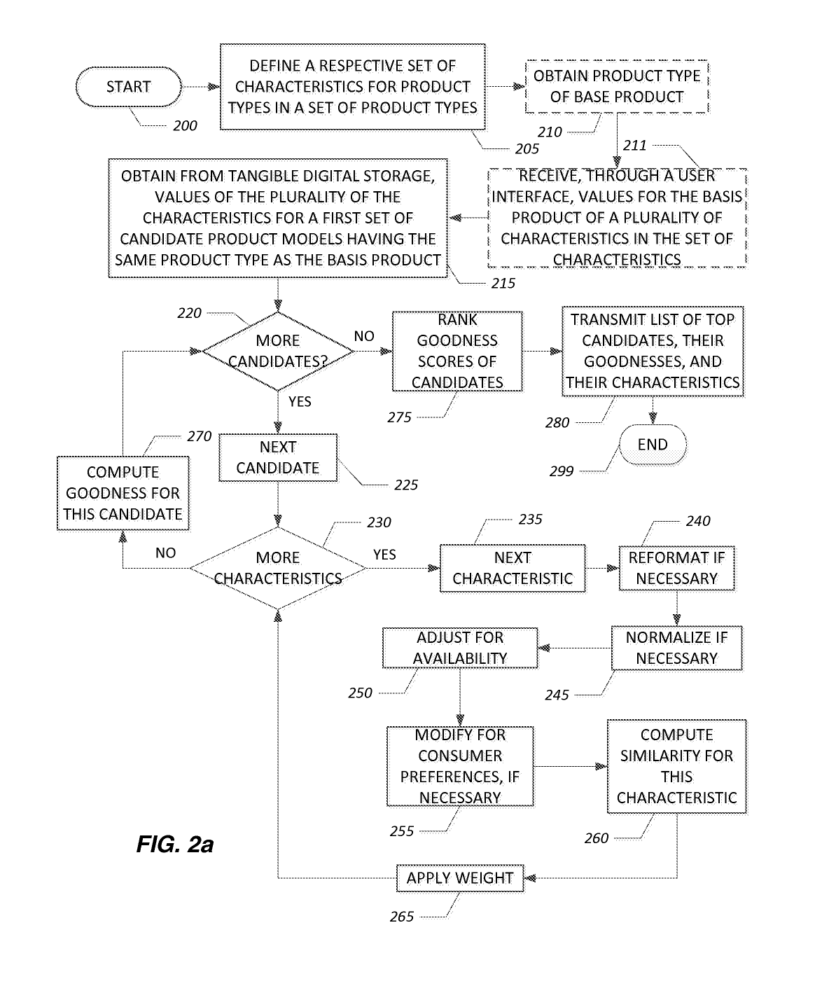

The product 140 might not be carried by this particular provider 103, or the product 140 might be a legacy product 140, no longer produced. In this case, matching logic 150, such as that illustrated by FIG. 2a, might be applied to produce a list of comparable products 160 from a set of candidate products 151. On the other hand, if a product ID 143 for the basis product 100 may be readily determined by the salesperson, then matching logic 150, such as that illustrated by FIG. 2b, might be applied.

FIG. 2a is essentially the same example as FIG. 2b, but for the above difference, and shares the same numbering of steps. Two steps, which are included in FIG. 2a but not in FIG. 2b, are outlined with dashed lines; similarly, the one step, which is included in FIG. 2b but not in FIG. 2a, is similarly dashed.

After the start 200 in FIG. 2a, the set of product type characteristics 131 are defined 205 for the various product types 130. The particular definitions might persist over multiple repetitions of the remaining steps. The product type 130 of the presented basis product 100 is obtained 210. For example, the matching logic 150 might receive a specification from a salesperson, using a local computer in a store, that the basis product 100 is a camera. The salesperson might then be presented through a user interface with a form to complete about the characteristic values 141 corresponding to the product type 130 of the basis product 100.

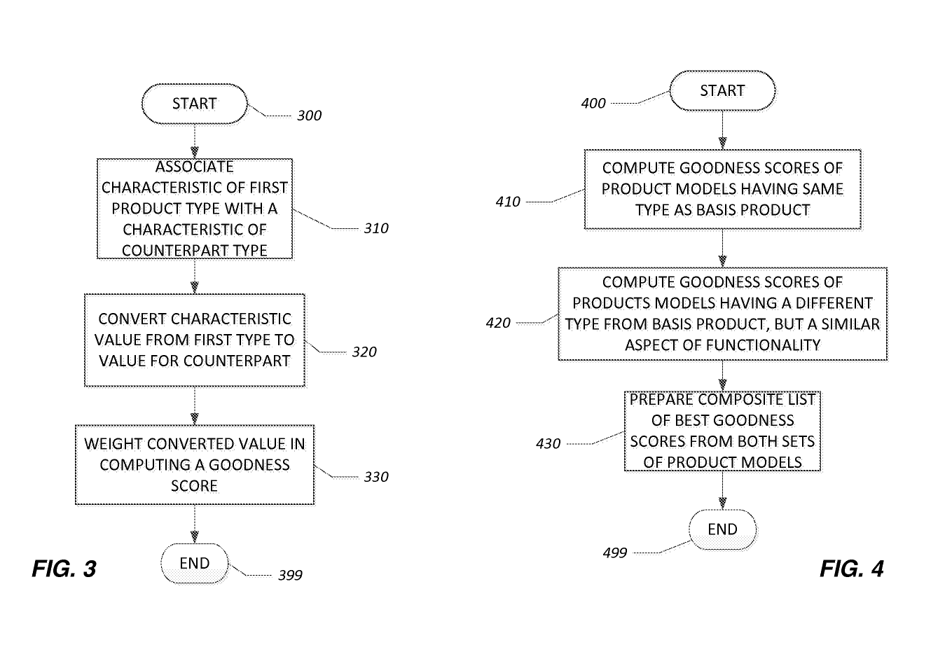

From storage 540, a set of candidate products 151 (strictly speaking, product models—e.g., a Honda Civic—rather than individual realizations of those models—e.g., my Honda Civic), along with their characteristic values 141 is obtained 215 by the processing system. These candidate products 151 have the same product type 130 as the basis product 100. The word “first” is used in this step because the matching logic 150 might also consider product types 130 different from that of the basis product 100, hence a second set of product type characteristics 131. See FIG. 4.

Steps numbered between 220 and 270 represent a loop through the candidate products 151. Within that loop is nested a loop through product type characteristics 131, between steps 230 and 265.

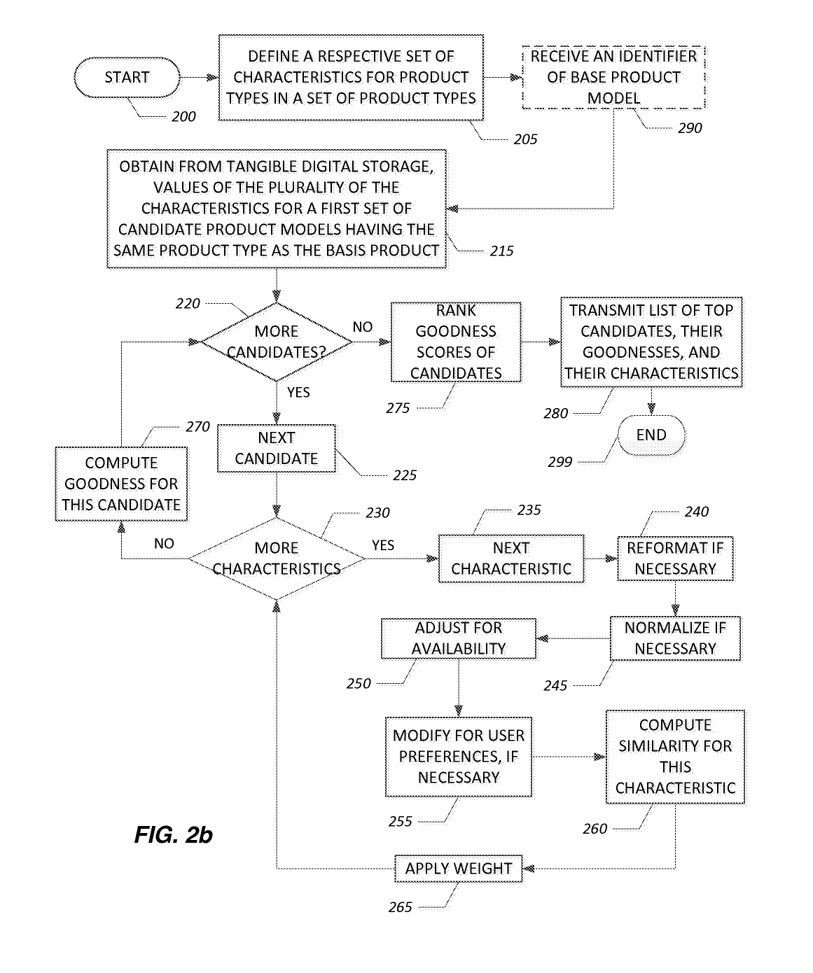

Reformatting 240 and normalizing 245 are steps that may be required to facilitate comparison of a product type characteristic 131 between the basis product 100 and the candidate 151. In FIG. 2a, these steps are shown within the both loops, but it might be possible to reformat or normalize the characteristic values 141 of the basis product 100 once, outside the loops. Normalization is discussed in more detail with respect to FIG. 3.

For a given product type characteristic 131 of a given candidate product 151, this exemplary method reformats 235, or cleanses, the characteristic value 141, if necessary. The reformatting puts the characteristic value 141 of the basis product 100 into condition to allow it to be compared, for example, by removing extraneous quotation marks. If a feature of the candidate 151 has functionality analogous to that of the basis product 100, but is configured differently, then either the value of the corresponding product type characteristic 131 may be normalized to that of the basis product 100, or conversely 245. In computing 260 a similarity for this product type characteristic 131 between the basis product 100 and the candidate 151, some adjustment 250 may be made for availability of the candidate 151, and preferences of the requester 102 may be taken into account 255. Note that we include measures of dissimilarity or difference in the term “similarity.” The similarity is a number, to which a weight factor may be applied 265.

As an example of the kinds of product type characteristics 131 that might be compared, consider a camera. Attributes that are compared might include some or all of the following: manufacturer; price; screen size; screen resolution; screen size; viewfinder type; waterproof or not; and image stabilizing or not; touch screen or not. Many other attributes might be compared as well.

After all product type characteristics 131 have been considered, a goodness score 270 may be computed for the candidate 151, for example, a weighted average of the individual similarities of the product type characteristics 131. The goodness scores of the candidates 151 are ranked 275, a list of top candidates 151 is transmitted 280. The process ends 299.

Variations of the ranking process are possible that take advantage of the goodness scores. For example, in a store environment, the best M (e.g., best 5) candidate products, based on goodness, available from the store itself might always be presented first; followed by the best N from nearby stores of the same retailer; followed by the best K available from a regional warehouse.

Note that in this flowchart and others, the practitioner in the art will recognize that steps may be performed in a different order. For example, a candidate product 151 might be ruled out as soon as it becomes clear that its goodness score is worse than a certain number of previously ranked candidate products 151. Also, some steps may be omitted, and others may be added, all within the inventive scope.

As previously mentioned, in FIG. 2b, it is assumed that a product ID 143 for the basis product 100 may be readily determined 290 from the outset. This eliminates form input of characteristic values 141 of the basis product 100.

FIG. 3 illustrates a process of normalization of features, such as when a product type characteristic 131 of a candidate 151 and that of the basis product 100 have similar functionality, but different configurations. For example, a 60 Hz LCD monitor might be considered comparable to a 480 Hz plasma monitor. As another example, normalization that might be performed with respect to the operating system of a computer or smart phone. Without normalization, only devices having the identical operating system would be considered; with normalization, a device might be considered comparable if it has a similar but different operating system, such an Android phone as a replacement for an iPhone.

After the start 300, the first product type characteristic 131 (e.g., refresh rate for an LCD monitor) is associated with 310, its counterpart product type characteristic 131 (e.g., refresh rate for a plasma monitor). Next, the first value characteristic value 141 is converted 320 to a characteristic value 141 for the counterpart. In computing a goodness score for the counterpart, the weight is applied 330 to the converted characteristic value 141.

FIG. 4 illustrates that the logic 150 might evaluate candidates 151 from more than one product type 130 in producing a set of comparables 160. For example, a person seeking a small laptop computer might want to consider a tablet computer instead. After the 400, goodness scores are computed 410 for products 140 having the same product type 130 as the basis product 100. Goodness scores are also computed 420 for one or more other product types 130. A composite list of comparables is prepared 430 based on the scores, drawing from all the product types 130 that have been considered. A person having skill in the art will realize that similar logic (not shown) will apply to a situation in both product types 130 differ from the type of the basis product 100.

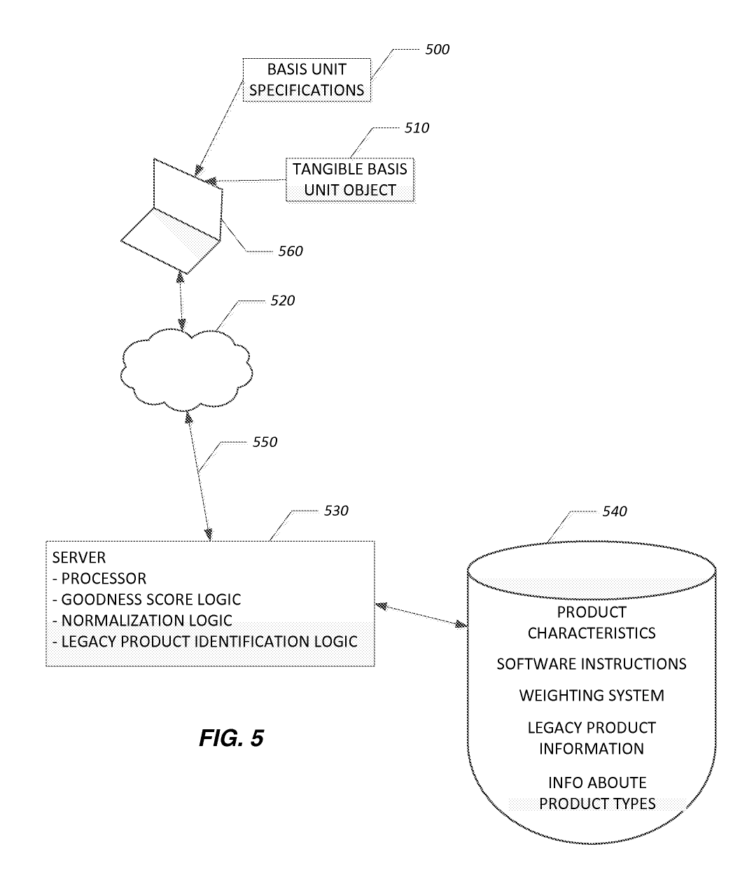

FIG. 5 illustrates a system that might be used to execute processes of the invention. This particular example might be used by a salesperson in a retail location to help a customer that brings in an old device (i.e., a basis object 510); or a sales receipt from a previous purchase (i.e., basis type specs 500), and wants something comparable but more up-to-date. The salesperson might assign weights to specific product type characteristics 131 or combinations of product type characteristics 131 based upon a conversation with the customer about preferences. The identifying information for the device, and any information from the customer about preferences, might be entered into a local computer 560 on the sales floor.

Digital communications in FIG. 5 are indicated by arrows, typified by arrow 550. Communication between the local computer 560 and a remote server 530 may be by any communication system 520. Any combination of such systems is itself a communication system 520, and may involve wires, wireless, local area networks, wide area networks, and so forth. The server 530 includes a processor and has access to tangible digital storage 540. the processor executes logic, in hardware or using software instructions, for methods of the invention, such as identifying comparable products 160 and obtaining their specifications; normalizing features; and computing goodness scores, ranking candidates, and transmitting a list of comparables back to the local computer 560. The storage 540 may include software instructions, and any data needed to carry out any processes of the invention. For example, the storage 540 may contain characteristics of SKUs and classes and subclasses of SKUs; information about products that are not in the current inventory; and/or information about doing weighting, normalization, and availability assessment.

Note that the processing logic and data might be physically located anywhere, depending on embodiment. For example, the server might be eliminated, with all processing functionality local. Data and/or processing functionality might be distributed among facilities.

The present invention is not limited to all the above details, as modifications and variations may be made without departing from the intent or scope of the invention. Consequently, the invention should be limited only by the following claims and equivalent constructions.

What is claimed is:

1. A method, comprising:
a) for each product type in a set of product types, defining a respective set of characteristics that characterize the product type;
b) obtaining a product type of a basis product;
c) obtaining from tangible digital storage the set of characteristics of the product type of the basis product;
d) receiving, through a user interface, values for the basis product of a plurality of the characteristics in the set of characteristics;
e) obtaining from tangible digital storage, values of the plurality of the characteristics for a first set of candidate product models having the same product type as the basis product, and
f) for each candidate product model in the first set of candidate product models, calculating, using a processing system, a goodness score, based on similarities of respective characteristics in the plurality of characteristics, between the basis product and the candidate product model.

2. The method of claim 1, the goodness score of a candidate product model being further based on a measure of availability of a product of the candidate product model.

3. The method of claim 1, wherein the first set of candidate product models correspond to tangible goods in an inventory that is represented by data in tangible storage.

4. The method of claim 1, wherein the basis product corresponds to a product model that is not included in the inventory.

5. The method of claim 1, further comprising:
g) applying processor logic that
(i) determines a respective weighted similarity score for each characteristic, between the basis product and the candidate product, and
(ii) computes the goodness score from the weighted similarity scores.

6. The method of claim 5, wherein determining a respective weighted similarity score is done for a characteristic that can assume only permissible values that are numerical and adapted to being ranked.

7. The method of claim 5, wherein determining a respective weighted similarity score is done for a characteristic that can assume only a finite number of discrete permissible values.

8. The method of claim 5, wherein determining a respective weighted similarity score is done for a characteristic can assume only permissible values that are text strings.

9. The method of claim 5, wherein determining a weighted similarity score is done for at least two of
(A) a first characteristic having permissible values that are numerical and adapted to being ranked,
(B) a second characteristic having a finite number of discrete permissible values, and
(C) a third characteristic having permissible values that are text strings.

10. The method of claim 5, wherein before determining a respective weighted similarity score for a particular characteristic, the logic normalizes a first value of the first characteristic to make the first value comparable to a second value of the particular characteristic.

11. The method of claim 5, wherein the processor logic further
(iii) modifies the determination of a similarity score based on a preference received through the user interface.

12. The method of claim 5, wherein before determining a respective weighted similarity score for a particular characteristic, the logic changes the format of the first characteristic to make the first value comparable to a second value of the particular characteristic.

13. The method of claim 1, further comprising:
g) identifying a second set of candidate product models having a different product type from the basis product;
h) for each candidate model in the second set of product models, calculating a goodness score between the basis product the second set of product models and the basis product;
i) ranking, in a single list, goodness scores of models in the first set of product models with goodness scores of models in the second set of product models; and
j) transmitting the ranked list through a hardware interface.

14. The method of claim 13, further comprising:
k) determining that a characteristic of the basis product has comparable functionality to, but uses different technology from, a characteristic of the product type of the second set of candidate product models.

15. A method, comprising:
a) for each product type in a set of product types, defining a respective set of characteristics that characterize the product type;
b) receiving an identifier of a basis product model that corresponds to the basis product;
c) using the identifier to determine the type of the basis product model;
d) obtaining from tangible digital storage, values of a plurality of characteristics for a first set of candidate product models having the same product type as the basis product, and
e) normalizing the value of a characteristic of either
(i) the basis product to make it comparable to a value of a characteristic of a candidate product model, or
(ii) a candidate product model to make it comparable to a value of a characteristic of the basis product, or
f) for each candidate product model in the first set of candidate product models, calculating, using a processing system, a goodness score, based on similarities of respective characteristics in the plurality of characteristics, between the basis product model and the candidate product model.

16. A system, comprising:
a) a processor;
b) logic, in hardware or in software instructions executed by the processor, that when executed,
(i) obtains a product type of a basis product;
(ii) obtains from tangible digital storage a set of characteristics of the product type of the basis product;
(iii) receives, through a user interface, values for the basis product of a plurality of characteristics that characterize the product type;
(iv) obtains from tangible digital storage, values of the plurality of the characteristics for a first set of candidate product models having the same product type as the basis product, and
(v) for each candidate product model in the first set of candidate product models, calculates, using a processing system, a goodness score, based on similarities of respective characteristics in the plurality of characteristics, between the basis product and the candidate product model.
